(19) United States
(12) Patent Application Publication
(10) Pub. No.: US 2026/0194660 A1
(43) Pub. Date: Jul. 9, 2026

(54) Color Depth Integration Method, Receiver, and Light Detection and Ranging Apparatus Thereof

(71) Applicant: Compertum Microsystems Inc., Hsinchu City (TW)

(72) Inventor: Francis Piu MAN, Hsinchu City (TW)

(73) Assignee: Compertum Microsystems Inc., Hsinchu City (TW)

(21) Appl. No.: 19/555,837

(22) Filed: Mar. 3, 2026

Related U.S. Application Data
(63) Continuation-in-part of application No. 18/372,146, filed on Sep. 25, 2023, now Pat. No. 12,591,060.

(51) Int. Cl. G01S 17/894; G01S 7/48; G01S 7/481; G01S 13/86

(52) U.S. Cl. CPC G01S 17/894; G01S 7/4802; G01S 7/4816; G01S 7/4817; G01S 13/865

(57) ABSTRACT

A receiver includes at least one detector macro-cell. Each of the at least one detector macro-cell includes a first detector, configured to capture first invisible radiation emitted from a first source and reflected by an object, a second detector, configured to capture first visible radiation reflected by or originating from the object, a third detector, configured to capture second visible radiation reflected by or originating from the object, and a fourth detector, configured to capture third visible radiation reflected by or originating from the object. The first visible radiation, the second visible radiation, and the third visible radiation may be red, green, and blue, respectively; alternatively red, green, and yellow, respectively; or alternatively cyan, magenta, and yellow, respectively. The first detector to the fourth detector are arranged in a first array to constitute one detector macro-cell.

### CROSS REFERENCE TO RELATED APPLICATIONS

This application is a continuation-in-part of U.S. Application No. 18/372,146, filed on September 25th, 2023. The content of the application is incorporated herein by reference.

### BACKGROUND OF THE INVENTION

### 1. FIELD OF THE INVENTION

The present invention relates generally to a color depth integration method, a receiver, and a light detection and ranging (LiDAR) apparatus thereof to fuse LiDAR with image sensing, and more particularly, to a color depth integration method, a receiver, and a LiDAR apparatus thereof for two-dimensional (2D) image capture and 3D depth measurement.

### 2. DESCRIPTION OF THE PRIOR ART

Autonomous mobile robots (e.g., robot vacuums) that draw increasing attention necessitate the ability of advanced environmental perception. Moreover, with the advent of Autonomous Driving Assistance System (ADAS), automobiles demand sensor fusion between a 2D image and a 3D point cloud, which is capable of reliably detecting and identifying objects, hazards, and obstacles for long ranges. Consequently, there is a need for a new type receiver able to perform both 2D visible light imaging and 3D nonvisible depth measurement.

### SUMMARY OF THE INVENTION

An embodiment of the present disclosure provides a receiver, comprising at least one detector macro-cell, wherein each of the at least one detector macro-cell comprises a first detector, configured to capture first invisible radiation, wherein the first invisible radiation represents radiation emitted from a first source and reflected by an object; a second detector, configured to capture first visible radiation reflected by or originating from the object; a third detector, configured to capture second visible radiation reflected by or originating from the object; and a fourth detector, configured to capture third visible radiation reflected by or originating from the object; wherein the first visible radiation, the second visible radiation, and the third visible radiation are red, green, and blue, respectively, the first visible radiation, the second visible radiation, and the third visible radiation are red, green, and yellow, respectively, or the first visible radiation, the second visible radiation, and the third visible radiation are cyan, magenta, and yellow, respectively; wherein the first detector to the fourth detector are arranged in a first array to constitute one detector macro-cell.

An embodiment of the present disclosure provides a light detection and ranging (LiDAR) apparatus, comprising a transmitter, comprising a first source; and a receiver, optically coupled to the transmitter and comprising at least one detector macro-cell, wherein each of the at least one detector macro-cell comprises a first detector, configured to capture first invisible radiation, wherein the first invisible radiation represents radiation emitted from the first source and reflected by an object; a second detector, configured to capture first visible radiation reflected by or originating from the object; a third detector, configured to capture second visible radiation reflected by or originating from the object; and a fourth detector, configured to capture third visible radiation reflected by or originating from the object, wherein the first visible radiation, the second visible radiation, and the third visible radiation are red, green, and blue, respectively, the first visible radiation, the second visible radiation, and the third visible radiation are red, green, and yellow, respectively, or the first visible radiation, the second visible radiation, and the third visible radiation are cyan, magenta, and yellow, respectively; wherein the first detector to the fourth detector are arranged in a first array to constitute one detector macro-cell.

An embodiment of the present disclosure provides a color depth integration method, comprising capturing, by a first detector of a detector macro-cell, first invisible radiation, wherein the first invisible radiation represents radiation emitted from a first source and reflected by an object; capturing, by a second detector of the detector macro-cell, first visible radiation reflected by or originating from the object; capturing, by a third detector of the detector macro-cell, second visible radiation reflected by or originating from the object; and capturing, by a fourth detector of the detector macro-cell, third visible radiation reflected by or originating from the object, wherein the first visible radiation, the second visible radiation, and the third visible radiation are red, green, and blue respectively, the first visible radiation, the second visible radiation, and the third visible radiation are red, green, and yellow respectively, or the first visible radiation, the second visible radiation, and the third visible radiation are cyan, magenta, and yellow respectively; wherein the first detector to the fourth detector are arranged in a first array to constitute the detector macro-cell.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an apparatus according to an embodiment of the present invention.

FIG. 2 to FIG. 4 are schematic diagrams of receivers according to embodiments of the present invention.

FIG. 5 to FIG. 10 are schematic diagrams of apparatuses according to embodiments of the present invention.

FIG. 11 is a schematic diagram of an apparatus according to an embodiment of the present invention.

FIG. 12 to FIG. 13 are schematic diagrams of receivers according to embodiments of the present invention.

### DETAILED DESCRIPTION

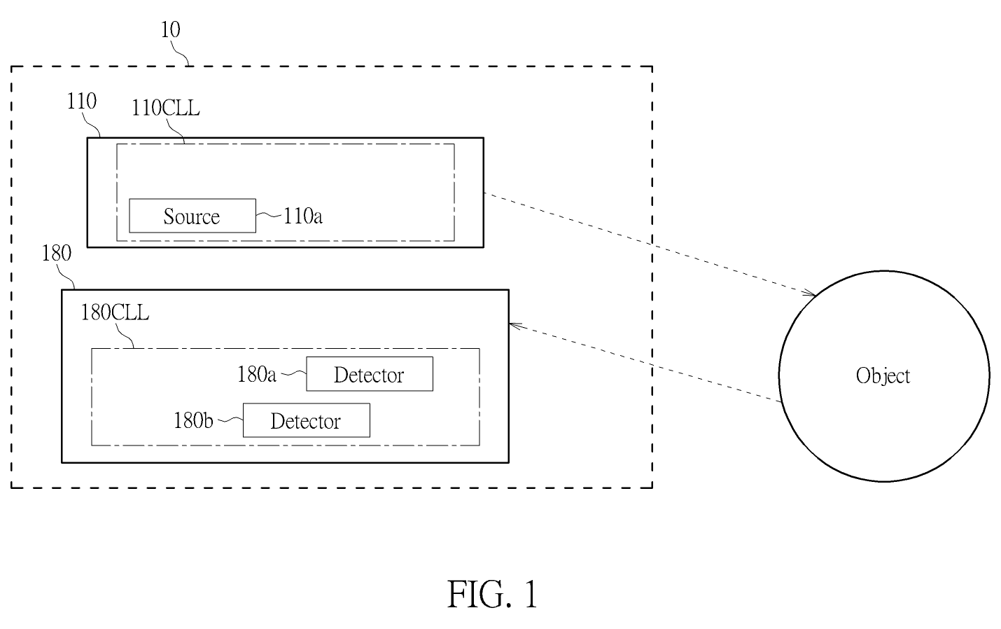

FIG. 1 is a schematic diagram of an apparatus 10 according to an embodiment of the present invention. The apparatus 10 (e.g., a LiDAR apparatus) may include a transmitter 110, which is configured to emit radiation, and a receiver 180.

The number of components shown in FIG. 1 may be adjusted. For example, the transmitter 110 may include one or more source macro-cells 110CLL, which are manufactured together, disposed on a single substrate, or packaged into a single device; the receiver 180 may include one or more detector macro-cells 180CLL, which are manufactured together, disposed on a single substrate, or packaged into a single device. The number of the detector macro-cell(s) 180CLL may be equal/proportional to or a multiple of the number of the source macro-cell(s) 110CLL.

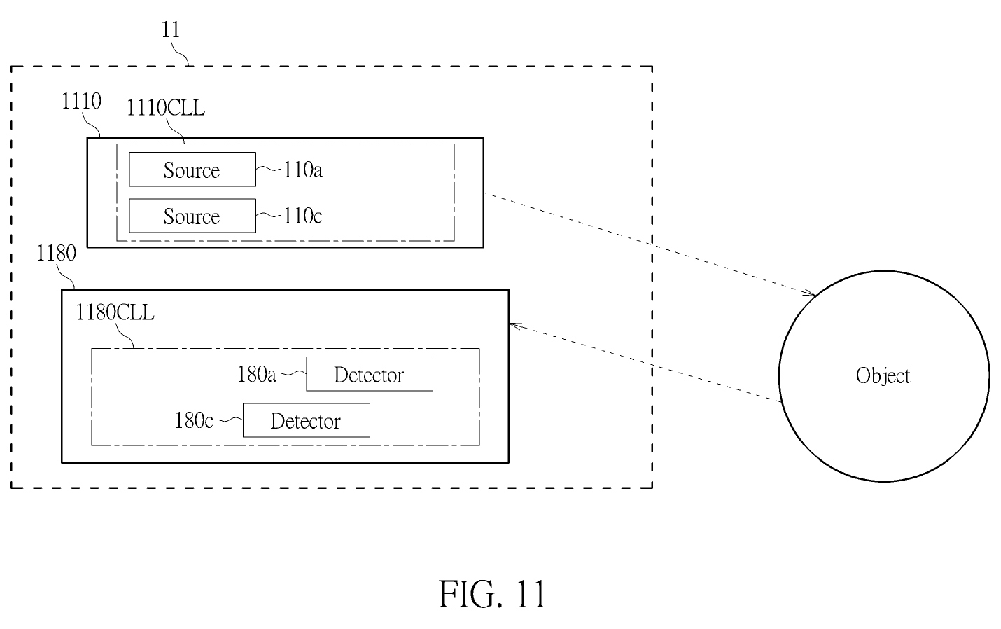

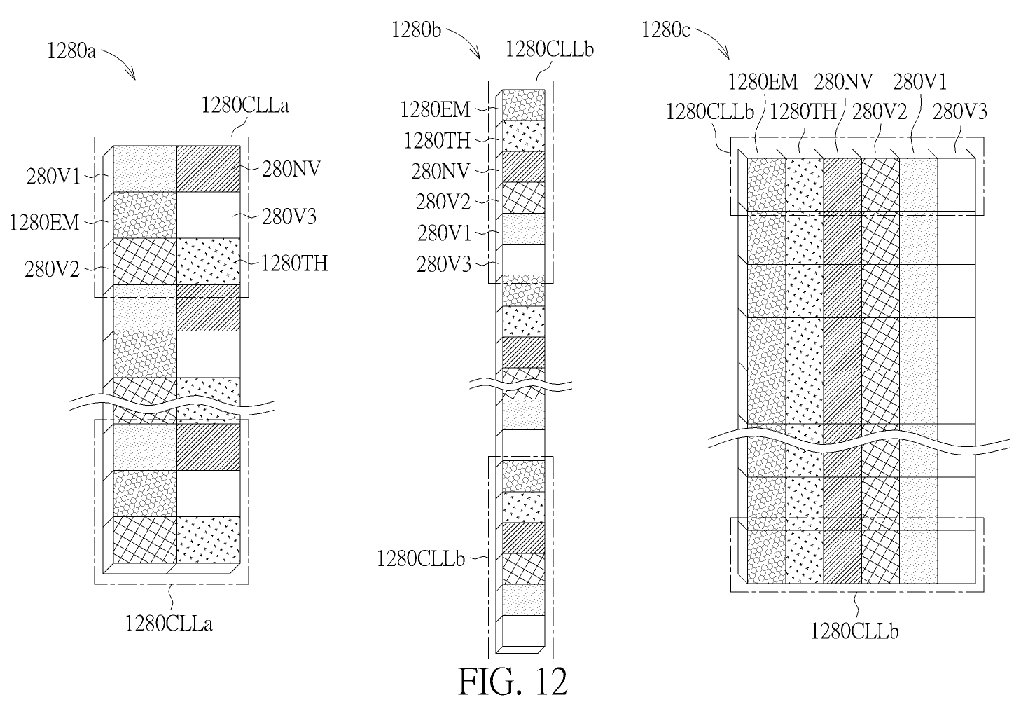

Each source macro-cell (e.g., 110CLL) may include a source (e.g., 110a), as shown in FIG. 1; alternatively, each source macro-cell (e.g., 1110CLL) may include sources (e.g., 110a and 110c), as shown in FIGS. 11 or 12.

Each detector macro-cell (e.g., 180CLL), which serves or is regarded as one (sensor) pixel, may include detectors (e.g., 180a and 180b). The number (e.g., 2) of the detectors (e.g., 180a and 180b) of one detector macro-cell (e.g., 180CLL) may exceed the number (e.g., 1) of the source(s) (e.g.,110a) of one source macro-cell (e.g., 110CLL), as shown in FIG. 1; alternatively, the number (e.g., 2) of the detectors (e.g., 180a and 180c) of one detector macro-cell (e.g., 1180CLL) may be equal to the number (e.g., 2) of the sources (e.g.,110a and 110c) of one source macro-cell (e.g., 1110CLL), as shown in FIG. 11.

Both the detectors (e.g., 180a and 180b) of one detector macro-cell (e.g., 1180CLL) may be disposed on a single substrate, formed monolithically, and fabricated by the same process/processes at once. However, the detectors 180a and 180b may be of different types, and may have different materials, structures, characteristics, mechanism, functions, or applications.

For example, the detector 180a may be configured to measure the distance to an object; the detector 180b may be configured to obtain color or thermal information of the object.

The detector 180a may be a detector for LiDAR or Radio-Detection-and-Ranging (radar) technology; the detector 180b may be a color imaging sensor, an image intensifier sensor, or a thermal imaging sensor.

The detector 180a may be configured to capture the corresponding reflected radiation representing the radiation reflected by an object. The detector 180a may be configured to respond exclusively to the transmitter 110a. On the other hand, the detector 180b may be configured to capture radiation which is reflected by or originating from the object. The detector 180b may be configured to sense its environment except the transmitter 110a (e.g., ambient/external radiation originated from the sun or environment and reflected by the object or ambient/thermal radiation emitted by the thermal motion of particles).

The detector 180a may be configured to detect radiation within a frequency band/range that matches radiation emitted from the source 110a. The detector 180b may be configured to detect radiation with frequencies at least partially different from the frequency band/range of the detector 180a; alternatively, the frequency band/range of the detector 180a may overlap that of the detector 180b.

The detector 180a may be configured to detect nonvisible/invisible radiation (e.g., near-infra-red light, an electromagnetic wave, a microwave, or a radio wave) corresponding to the nonvisible radiation transmitted from the source 110a. The electromagnetic wave may range from hundreds of mega Hertz to 77GHz. The detector 180b may be configured to detect nonvisible radiation (e.g., infra-red light) or visible radiation (e.g., red light).

The detectors 180a and 180b may be equipped with different kinds of filters or may operate without any filters. In an embodiment, the detector 180a is masked with a nonvisible band-pass filter of its detector macro-cell 180CLL, while the detector 180b is masked with a color filter or a nonvisible band-pass filter of its detector macro-cell 180CLL. In another embodiment, the detector 180a is a nonvisible detector sensitive to nonvisible radiation, while the detector 180b is a visible detector sensitive to visible radiation or a nonvisible detector, such that nonvisible band-pass filter(s) and color filter(s) are absent from the apparatus 10.

The detector 180b may be physically implemented similarly to or different from the detector 180a. The detector 180a may be, for example but not limited thereto, a photo-detector, a photodiode, a photo-resistor, an avalanche photodiode (APD), a Geiger mode avalanche photodiode, a silicon based single photon avalanche diode (SPAD), a silicon photomultiplier (SiPM), a Germanium-on-silicon SPAD, or an InGaAs/InP SPAD.

In other words, only the detector 180a responds to the source 110a and may measure the time difference between the radiation emitted from the source 110a and the reflected radiation corresponding to the emitted radiation.

Therefore, for each pixel (which corresponds to one detector macro-cell 180CLL), the detector macro-cell 180CLL can comprehensively determine the distance to (a point of) an object using the detector 180a and determine the appearance/color/category of (the point of) the object using the detector 180b at once. Accordingly, the apparatus 10 may provide a color image of object(s) and its corresponding 3D representation known as point cloud data, which is created by collecting distance-to-object-data and includes a (discrete) set of data points. Each data point of point cloud data thus has its set of Cartesian coordinates (x, y, z) with its color constructed through a combination of (intensity) values for, for example, red, green and blue light. Alternatively, the apparatus 10 may provide data points of point cloud data, each has its set of Cartesian coordinates (x, y, z), and indicate that the data points correspond to a biotic/living entity or an abiotic/non-living entity.

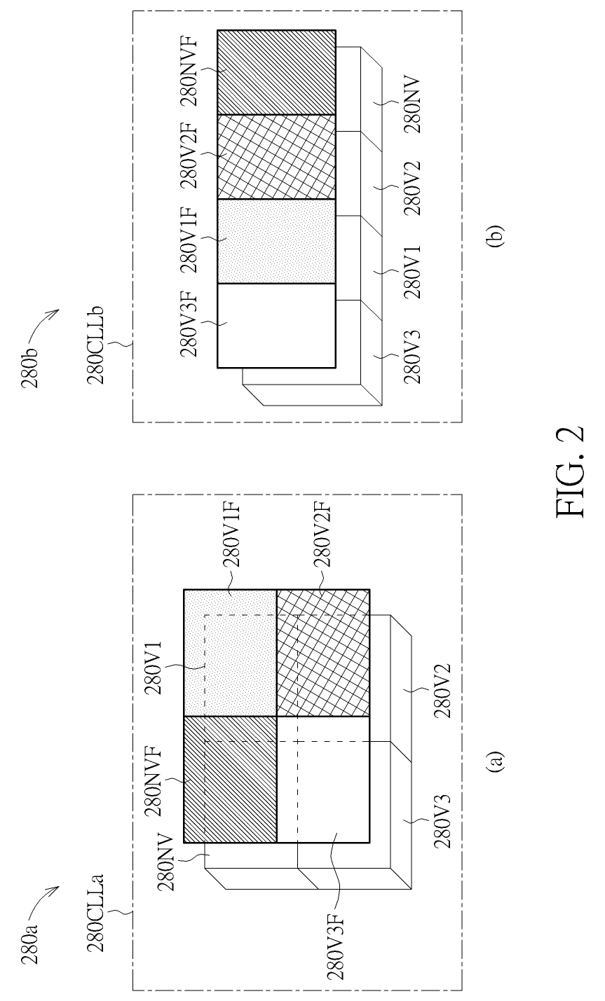

FIG. 2 is a schematic diagram of receivers 280a and 280b according to embodiments of the present invention. The receivers 280a and 280b may include detector macro-cells 280CLLa and 280CLLb, respectively. The detector macro-cell 180CLL may be implemented using the detector macro-cell 280CLLa or 280CLLb.

The detector macro-cell 280CLLa or 280CLLb may include detectors 280NV and 280V1-280V3. In an embodiment, the detector 280NV may be used to implement the detector 180a, while the detector 280V1, 280V2, or 280V3 may be used to implement the detector 180b.

The detectors 280NV and 280V1-280V3 may have different or identical size (e.g., 10×10 square micrometers) or shape.

The detectors 280NV and 280V1-280V3, disposed adjacent to one another, may be arranged in an array to constitute one detector macro-cell.

The arrangement of a detector macro-cell may vary according to different consideration: For example, one detector corresponding to the longest wavelength (e.g., a detector covered by an infrared band-pass or an infrared detector) may be disposed far from another detector corresponding to the second longest wavelength (e.g., a detector covered by a red color filter or a red detector) as shown in FIG. 2 (a). Alternatively, the arrangement of detectors of a detector macro-cell may be sequenced in the increasing/decreasing order of wavelength as shown in FIG. 2 (b).

The detectors 280NV and 280V1-280V3 may be masked with filters 280NVF and 280V1F-280V3F of different frequency bands/ranges, such that the detectors 280NV and 280V1-280V3 may respond to, for example, infrared, green, red, and blue radiation, respectively. Alternatively, the detectors 280NV and 280V1-280V3 may respond to infrared, green, red, and yellow radiation, respectively. Alternatively, the detectors 280NV and 280V1-280V3 may respond to infrared, magenta, cyan, and yellow radiation, respectively. In an embodiment, the filters 280NVF, 280V1F-280V3F and another filter may be an infrared band-pass, a magenta color, a cyan color, a yellow color, and a black/key color filter, respectively.

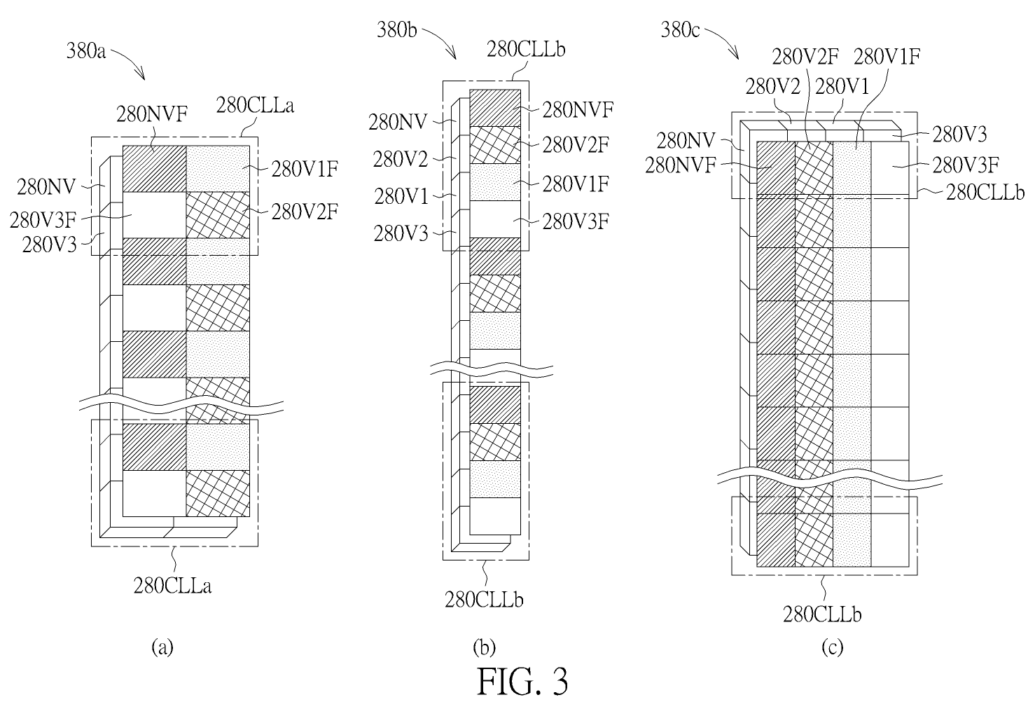

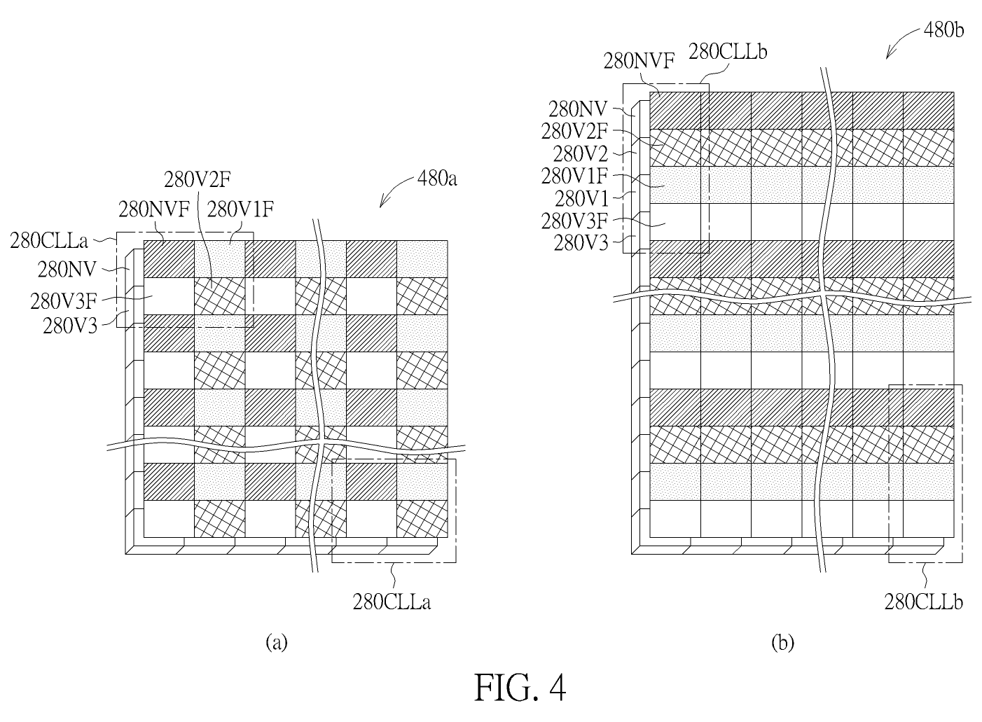

FIG. 3 is a schematic diagram of receivers 380a, 380b, and 380c according to embodiments of the present invention. FIG. 4 is a schematic diagram of receivers 480a and 480b according to embodiments of the present invention.

Each of the receivers 380a and 480a may include detector macro-cells 280CLLa shown in FIG. 2 (a). The identical detector macro-cells 280CLLa, having identical structures, may be disposed adjacent to one another to form an array.

Each of the receivers 380b-380c and 480b may include detector macro-cells 280CLLb shown in FIG. 2 (b). The identical detector macro-cells 280CLLb, having identical structures, may be disposed adjacent to one another to form an array.

For example, the detector macro-cells 280CLLa of the receiver 380a (or the detector macro-cells 280CLLb of the receiver 380b or 380c) may be arranged in a 1D array (such as a line, row, or column) for certain mode (e.g., a 1D line-scan mode). The detector macro-cells 280CLLa of the receiver 480a (or the detector macro-cells 280CLLb of the receiver 480b) may be arranged in a 2D array for certain mode (e.g., an area mode or a flash mode). The receiver 480b may be utilized in a 1D line-scan mode as well.

In an embodiment, the number of all the detector macro-cell(s) may be equal/proportional to or a multiple of the number of all the source macro-cell(s) (e.g., in a single spot mode, in a flash mode, a 2D raster-scan mode, or a 1D line-scan mode). In another embodiment, the number of columns/rows of all the detector macro-cell(s) may be equal/proportional to or a multiple of the number of all the source macro-cell(s) (e.g., in a 1D line-scan mode).

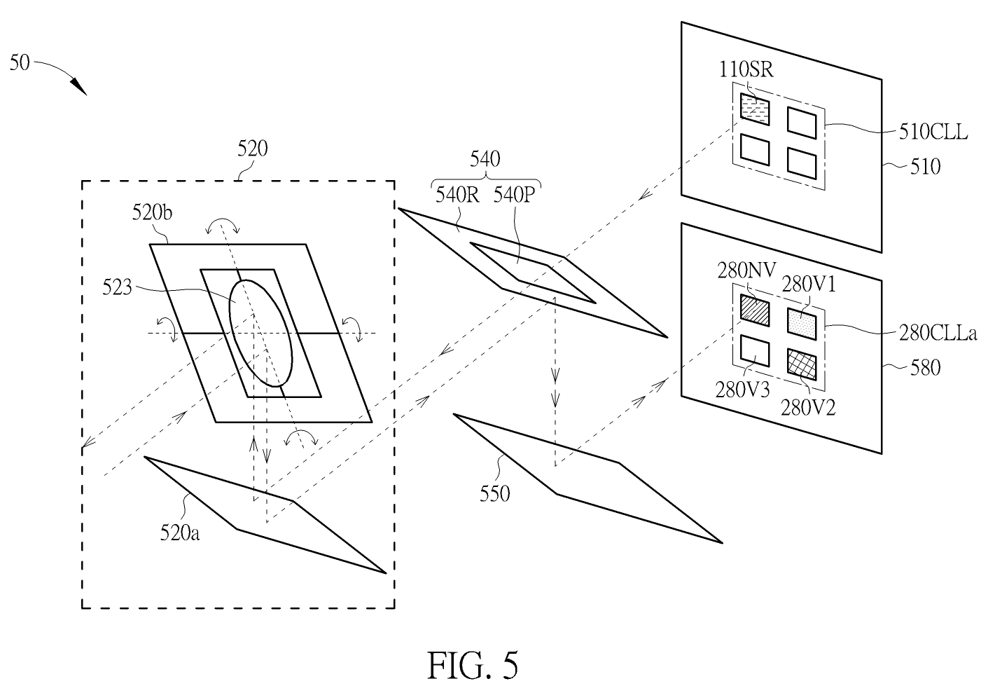

FIG. 5 is a schematic diagram of an apparatus 50 according to an embodiment of the present invention. The apparatus 50 may include a transmitter 510, a beam steering unit 520, an optical separator 540, an optical deflector 550, and a receiver 580 optically coupled to each other.

In an embodiment, the receiver 580 may include one detector macro-cell 280CLLa shown in FIG. 2 (a). In another embodiment, instead of the detector macro-cell 280CLLa, the receiver 580 may include one detector macro-cell 280CLLb shown in FIG. 2 (b).

Corresponding to the receiver 580 including one detector macro-cell 280CLLa, the transmitter 510 may include one source macro-cell 510CLL.

As shown in FIG. 5, the source macro-cell 510CLL may include one source 110SR, which may be implemented using the source 110a or 110c shown in FIGS. 1 or 11. Alternatively, the source macro-cell 510CLL may include more sources (e.g., 110SR), like the source macro-cell 1110CLL shown in FIG. 11. In other words, the total number (e.g., 4) of all the detectors 280NV and 280V1-280V3 is a multiple of the total number (e.g., 1, 2, 3 or 4) of all the source(s).

The arrangement of the source(s) of one source macro-cell 510CLL may match the arrangement of the detectors of one detector macro-cell 280CLLa. For example, the source 110SR may be disposed in the top left corner (relative to its source macro-cell 610CLL), corresponding to the detector 280NV.

In this embodiment, the optical separator 540 may include a reflective surface 540R and have an opening 540P near the center of the reflective surface 540R, such that the radiation from the source 110SR may passes through the opening 540P without changing direction (but possibly with beam offset or spatial shift) while radiation reflected by or originating from object(s) may be redirected to the optical deflector 550 by the reflective surface 540R. The opening 540P may be an aperture/hole with a shape (e.g., a rectangle or circle) similar to that of the reflective surface 540R. In another embodiment, the optical separator 540 may be a beam-splitter or polarizing beam-splitter although its beam-splitting properties may not be ideal because the ratio of reflection to transmission may vary between wavelengths.

The beam steering unit 520 may include steering components 520a and 520b. A reflective surface 523 of the (adjustable) steering component 520b, the (stationary) steering component 520a, the reflective surface 540R, and the optical deflector 550 may have reflective coverings (e.g., mirrors) to manipulate radiation path through bending.

As shown in FIG. 5, the receiver 580 is disposed next to the transmitter 510 to make the apparatus 50 coaxial. Moreover, the radiation entering the beam steering unit 520 and the radiation exiting the beam steering unit 520 are substantially parallel or coaxial.

In this embodiment, the apparatus 50 may leverage coaxial optical mechanism and scan the entire field of view (FOV) by moving/rotating the steering component 520b of the beam steering unit 520 in a single spot mode. In another embodiment, as described in US Applications No. 17/900,864, the receiver 580 may include more detector macro-cells 280CLLa to collecting the reflected pulse radiation beams simultaneously as one flash LiDAR, and the transmitter 510 may include more source macro-cells 510CLL to emit pulse radiation beams at once as one flash LiDAR.

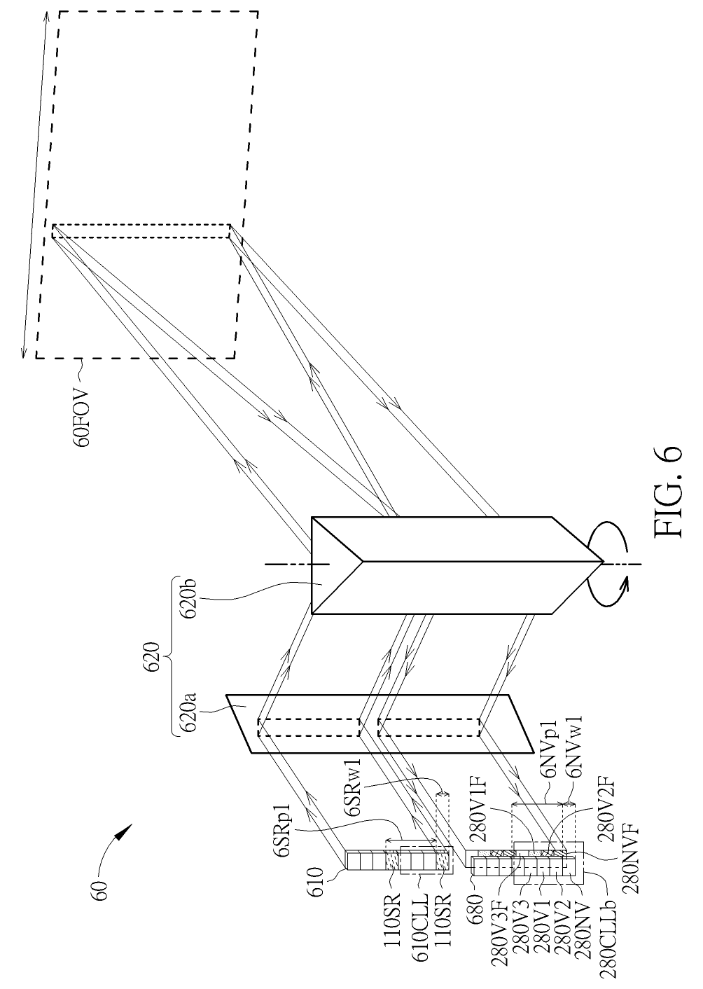

FIG. 6 is a schematic diagram of an apparatus 60 according to an embodiment of the present invention. The apparatus 60 may include a transmitter 610, a beam steering unit 620, and a receiver 680.

As shown in FIG. 6, the receiver 680 may include two detector macro-cells 280CLLb shown in FIG. 2 (b). Alternatively, the receiver 680 may include more than two detector macro-cells 280CLLb as the receiver 380c.

Corresponding to the receiver 680 including two (or more) detector macro-cells 280CLLb arranged in a 1D array, the transmitter 610 may include two (or more) source macro-cells 610CLL lined up into a 1D array.

As shown in FIG. 5, the source macro-cell 610CLL may include one source 110SR, which may be implemented using the source 110a or 110c shown in FIGS. 1 or 11. Alternatively, the source macro-cell 610CLL may include more sources (e.g., 110SR), like the source macro-cell 1110CLL shown in FIG. 11. In other words, the total number (e.g., 8) of all the detectors 280NV and 280V1-280V3 is a multiple of the total number (e.g., 2, 4, 6 or 8) of all the sources.

The arrangement of the source(s) of one source macro-cell 610CLL may match the arrangement of the detectors of one detector macro-cell 280CLLb. For example, the source 110SR may be disposed at the bottom (relative to its source macro-cell 610CLL), corresponding to the detector 280NV.

In an embodiment, the ratio of a pitch 6NVp1 between one detector 280NV and another adjacent detector 280NV in a direction (e.g., vertically) to a width 6NVw1 of one detector 280NV in the same direction is proportional to the ratio of a pitch 6SRp1 between one source 110SR and another adjacent source 110SR in that direction to a width 6SRw1 of one source 110SR in that direction.

The beam steering unit 620 may include a (stationary) steering component 620a and a (adjustable) steering component 620b, which may have reflective coverings (e.g., mirrors) to bend radiation. The apparatus 60 may scan the entire FOV 60FOV by moving/rotating the steering component 620b in a 1D line-scan mode. The shape of the steering component 620b may be a prism or a polyhedron made of triangular bases, rectangular/square bases, or other polygon bases. For example, when the steering component 620b has two triangular bases as shown in FIG. 6, the FOV 60FOV may be 360/3=120 degrees. For example, when the steering component 620b has two regular-pentagon bases or is a uniform pentagonal prism, the FOV may be 360/5=72 degrees.

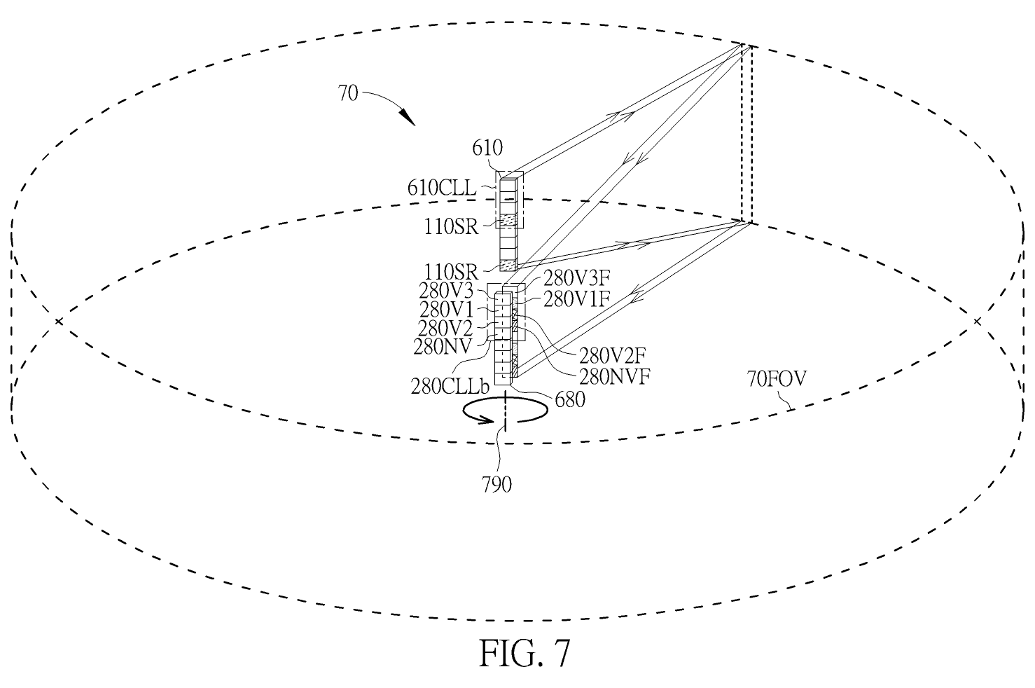

FIG. 7 is a schematic diagram of an apparatus 70 according to an embodiment of the present invention. The apparatus 70 may include the transmitter 610, the receiver 680, and a rotatable mover 790 (e.g., a motor). The rotatable mover 790 may facilitate the rotation of both the transmitter 610 and the receiver 680 to scan the entire FOV 70FOV (of 360 degrees) in a 1D line-scan mode.

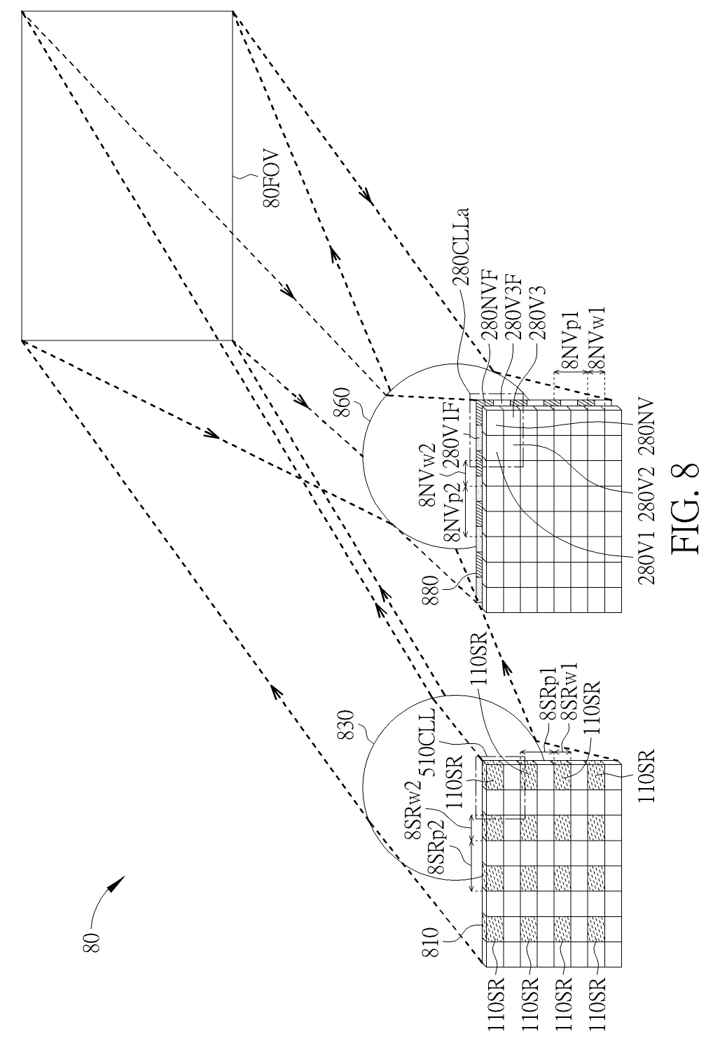

FIG. 8 is a schematic diagram of an apparatus 80 according to an embodiment of the present invention. The apparatus 80 may include a transmitter 810, optical curving units 830, 860, and a receiver 880. The optical curving unit 830 or 860 may be a lens. The transmitter 810 sends out (pulse) radiation, which illuminates the whole entire FOV 80FOV at once in a (non-coaxial) flash mode.

As shown in FIG. 8, the receiver 880 may include 4×4 detector macro-cells 280CLLa shown in FIG. 2 (a). Alternatively, the receiver 880 may include more detector macro-cells 280CLLa as the receiver 480a. Moreover, the total number (e.g., 56) of all the detectors 280NV and 280V1-280V3 is a multiple of the total number (e.g., 16, 32, 48, or 56) of all the sources.

Corresponding to the receiver 880 including 4×4 (or more) detector macro-cells 280CLLa arranged in a 2D array, the transmitter 810 may include 4×4 (or more) source macro-cells 510CLL arranged in a 2D array.

In an embodiment, the ratio of a pitch 8NVp1 (or 8NVp2) between one detector 280NV and another adjacent detector 280NV in a direction (e.g., vertically or horizontally) to a width 8NVw1 (or 8NVw2) of one detector 280NV in the same direction is proportional to the ratio of a pitch 8SRp1 (or 8SRp2) between one source 110SR and another adjacent source 110SR in that direction to a width 8SRw1 (or 8SRw2) of one source 110SR in that direction.

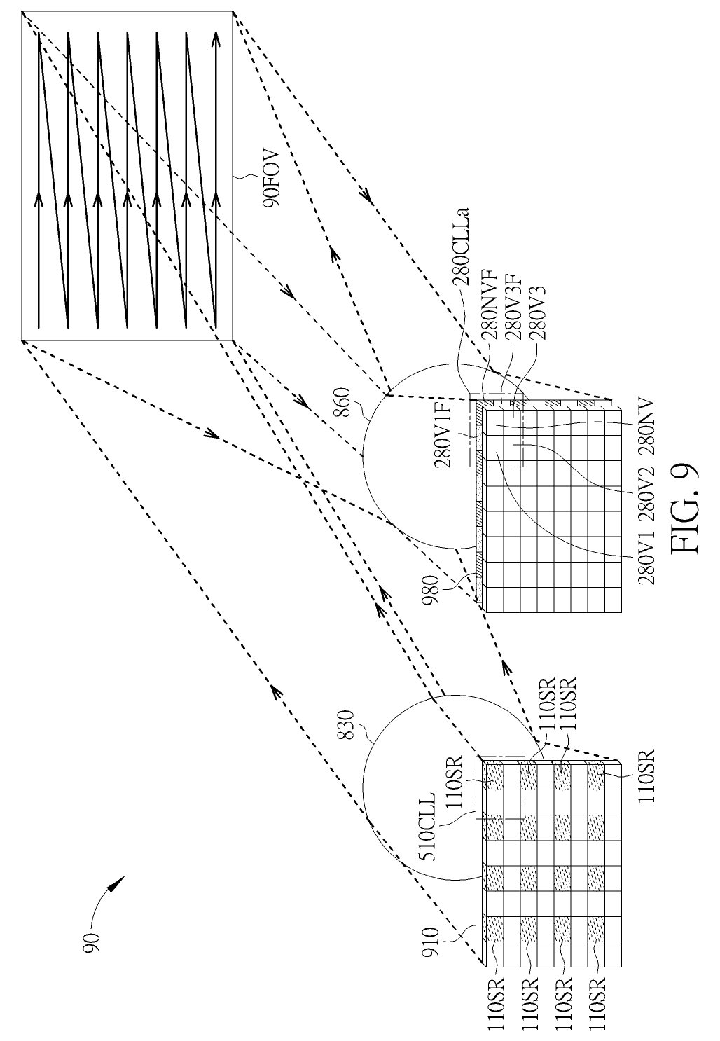

FIG. 9 is a schematic diagram of an apparatus 90 according to an embodiment of the present invention. The apparatus 90 may include a transmitter 910, the optical curving units 830, 860, and the receiver 980.

Corresponding to the receiver 980 including 4×4 (or more) detector macro-cells 280CLLa arranged in a 2D array, the transmitter 910 may include 4×4 (or more) source macro-cells 510CLL arranged in a 2D array.

Each source 110SR is individual addressable or able to be individually activated to scan the entire FOV 90FOV (of 360 degrees) in a (non-coaxial) 2D scan mode. In an embodiment, only one individual source 110SR is activated to fire up a radiation beam at a time. In an embodiment, only sources 110SR in one column/row are activated to fire up a radiation beam at a time.

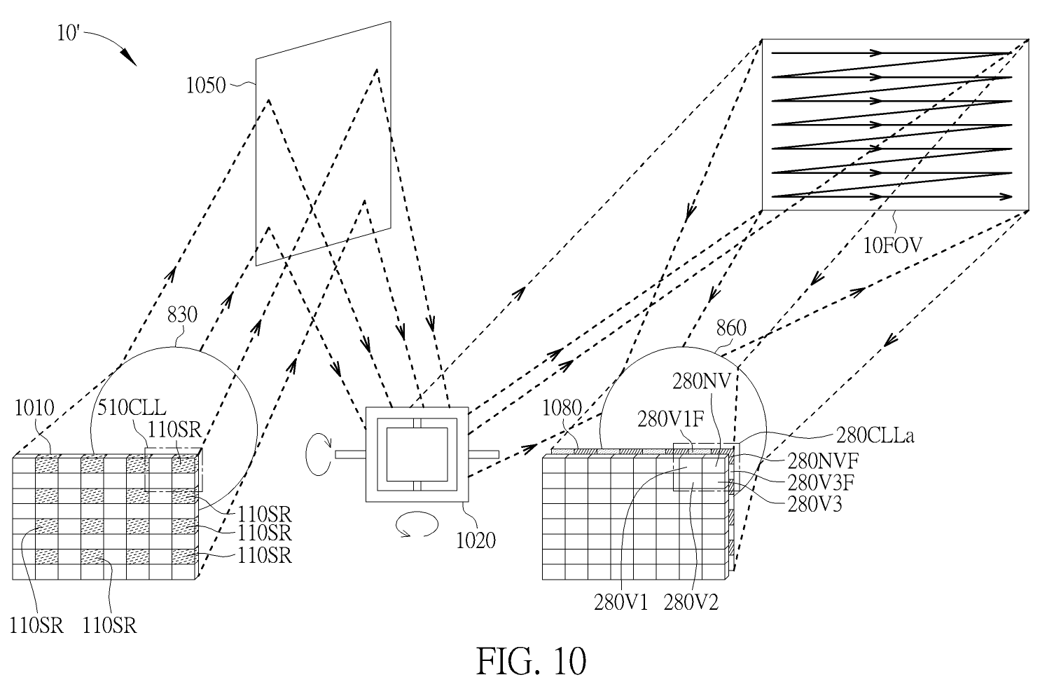

FIG. 10 is a schematic diagram of an apparatus 10’ according to an embodiment of the present invention. The apparatus 10’ may include a transmitter 1010, the optical curving units 830, 860, a beam steering unit 1020, an optical deflector 1050, and the receiver 1080.

The beam steering unit 1020 and the optical deflector 1050 may have reflective coverings (e.g., mirrors) to bend radiation. The beam steering unit 1020 may include a rotatable mirror or a microelectromechanical systems (MEMS) mirror. In this embodiment, the apparatus 10’ may scan the entire FOV 10FOV by moving/rotating the beam steering unit 1020 in a (non-coaxial) 2D scan mode. In another embodiment, as described in US Applications No. 18/084,562, the (radiation) receiver may capture the reflected radiation from one FOV at a time to obtain high spatial resolution point cloud data as (beam) steering components of a beam steering unit are activated sequentially to multiplex the reflected radiation from different FOVs.

As shown in FIG. 5 to FIG. 10, for each pixel (which corresponds to one detector macro-cell 280CLLa or 280CLLb), the detector macro-cell 280CLLa or 280CLLb can comprehensively measure the distance to (a point of) an object using the detector 280NV and recognize the appearance/color (of the point) of the object using the detectors 280V1-280V2 at a time.

FIG. 11 is a schematic diagram of an apparatus 10’ according to an embodiment of the present invention. The apparatus 10’ may include a transmitter 1110 and a receiver 1180.

As set forth above, each source macro-cell (e.g., 1110CLL) of the transmitter 1110 may include sources (e.g., 110a and 110c), as shown in FIG. 11. The sources 110a and 110c may be of different types, and may have different materials, structures, characteristics, or mechanism.

Each detector macro-cell (e.g., 1180CLL), which serves or is regarded as one (sensor) pixel, of the receiver 1180 may include detectors (e.g., 180a and 180c), as shown in FIG. 11. The detectors 180a and 180c may be configured to measure the distance to the same object; however, the detectors 180a and 180c may be of different types, and may have different materials, structures, characteristics, or mechanism. For example, the detector 180a may be configured to detect near-infra-red light which is emitted from the source 110a and reflected by the object. The detector 180c may be configured to detect an electromagnetic wave, a microwave, or a radio wave which is emitted from the source 110c and reflected by the object.

Integrating LiDAR and radar technologies enables the capture of fine details, improves speed accuracy, and supports long-range detection under adverse environmental conditions, thereby providing enhanced safety.

FIG. 12 is a schematic diagram of receivers 1280a, 1280b, and 1280c according to embodiments of the present invention. The receiver 1280a, 1280b, or 1280c may include detector macro-cells 1280CLLa or 1280CLLb.

The detector macro-cell 1280CLLa or 1280CLLb may include detectors 1280EM, 280NV, 1280TH, and 280V1-280V3. In an embodiment, the detectors 280NV and 1280EM may be used to implement the detector 180a and 180c, respectively, while the detector 1280TH, 280V1, 280V2, or 280V3 may be used to implement the detector 180b.

For example, the detector 1280EM or 280NV may be configured to measure the distance to an object. The detector 1280TH may be configured to obtain thermal information of the object. The detector 280V1, 280V2, or 280V3 may be configured to obtain color information of the object.

The detector 1280EM may be a detector for radar technology. The detector 280NV may be a detector for LiDAR technology. The detector 1280TH may be a thermal imaging sensor. The detector 280V1, 280V2, or 280V3 may be a color imaging sensor or an image intensifier sensor

The detector 1280EM may be configured to detect the corresponding reflection of an electromagnetic wave (e.g., a microwave or a radio wave) emitted from the source 110a. The electromagnetic wave may range from 1 millimeter to 1 meter. The detector 280NV may be configured to detect the corresponding reflection of near-infra-red light emitted from the source 110c. The near-infra-red light may range from 905 to 1550 nanometers. The detector 1280TH may be configured to detect infra-red light originating from the object. The infra-red light may range from 3 to 14 micrometers. The detector 280V1, 280V2, or 280V3 may be configured to detect visible light (e.g., red, green, or blue light) reflected by or originating from the object.

As shown in FIG. 12, the detectors 1280EM, 280NV, 1280TH, and 280V1-280V3 may operate without any filters. Alternatively, some of them may be equipped with different kinds of filters.

The detectors 1280EM, 280NV, 1280TH, and 280V1-280V3 may have different or identical size (e.g., 10×10 square micrometers) or shape.

The detectors 1280EM, 280NV, 1280TH, and 280V1-280V3, disposed adjacent to one another, may be arranged in an array to constitute one detector macro-cell 1280CLLa or 1280CLLb. The identical detector macro-cells 1280CLLa (or 1280CLLb), having identical structures, may be disposed adjacent to one another to form an array. All the detectors 1280EM, 280NV, 1280TH, and 280V1-280V3 may be disposed on a single substrate, formed monolithically, and fabricated by the same process/processes at once.

As shown in FIG. 12, for each pixel (which corresponds to one detector macro-cell 1280CLLa or 1280CLLb), the detector macro-cell 1280CLLa or 1280CLLb can comprehensively measure the distance to (a point of) an object using the detectors 280NV and 1280EM, recognize the appearance/color (of the point) of the object using the detectors 280V1-280V2, and indicate that (the point) of the object correspond to a biotic/living entity or an abiotic/non-living entity, at a time. Moreover, the detector macro-cell 1280CLLa or 1280CLLb integrates LiDAR and radar technologies to enhance accuracy and safety.

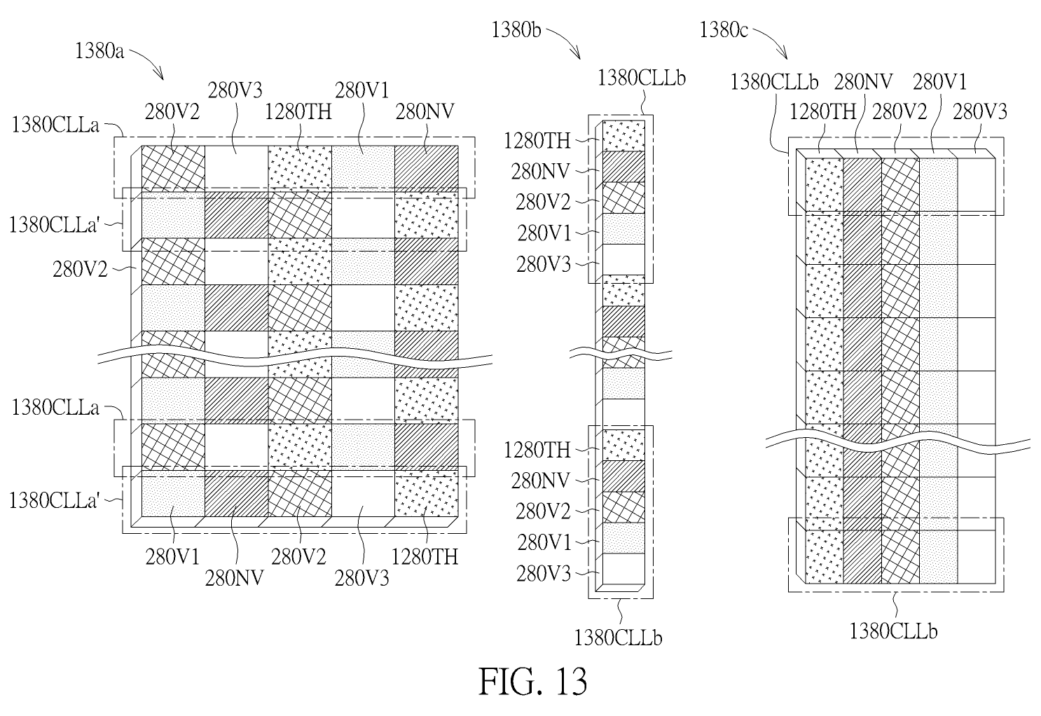

FIG. 13 is a schematic diagram of receivers 1380a, 1380b, and 1380c according to embodiments of the present invention. The receiver 1380a may include detector macro-cells 1380CLLa or 1380CLLa’. The receiver 1380b or 1380c may include detector macro-cells 1380CLLb. The detector macro-cell 1380CLLa, 1380CLLa’, or 1380CLLb may include detectors 280NV, 1280TH, and 280V1-280V3.

The arrangement of one detector macro-cell may vary according to different consideration: For example, the arrangement of detectors of one detector macro-cell may be sequenced in the increasing/decreasing order of wavelength as shown in FIG. 13 (b): The sequence may be a thermal imaging sensor, a LiDAR detector, a color imaging sensor. Alternatively, one detector corresponding to the longest wavelength (e.g., a thermal imaging sensor) may be disposed far from another detector corresponding to the second longest wavelength (e.g., a LiDAR detector), as shown in FIG. 13 (a).

A color depth integration method, which may be compiled into a code and executed by an apparatus (e.g., any of 10, 10’, 11, 50-90) or a device (e.g., a server, a central processing unit (CPU), or a graphics processing unit (GPU)) communicatively coupled to the apparatus, may include the following steps:

Step S04: Enable a transmitter (e.g., any of 110-1110) to emit (nonvisible) radiation. Go to Step S06.

Step S06: Enable a detector (e.g., 180a or 180c) of a detector macro-cell (e.g., 180CLL or 1180CLL) to capture reflected radiation representing the radiation emitted from the transmitter and enable another detector (e.g., 180b) of the same detector macro-cell to capture ambient radiation. In another embodiment, more detectors (e.g., 1280EM and 280NV) of the same detector macro-cell (e.g., 1280CLLa or 1280CLLb) may be enabled to capture the corresponding reflection emitted from different sources. In another embodiment, more detectors (e.g., 1280TH, 280V1, 280V2, or 280V3) of the same detector macro-cell (e.g., 280CLLa, 280CLLb, 1280CLLa, 1280CLLb, 1380CLLa, 1380CLLa’, or 1380CLLb) may be enabled to capture ambient radiation within different frequency bands. The (nonvisible) reflected radiation and the visible/nonvisible ambient radiation may be obtained by the apparatus concurrently or at different time. The visible/nonvisible ambient radiation may be obtained by the apparatus simultaneously. Go to Step S08.

Step S08: Associate/link a distance to a point in space (e.g., a point on an object) with color/thermal information of the point. Therefore, each point is characterized by a unique set of Cartesian coordinates (x, y, z) and its color/thermal information presenting through a combination of the intensity of different radiation.

One or more of Steps S04 to S08 may be removed depending on different considerations.

Details or modifications of a beam steering unit, a steering component, an optical deflector, a (radiation) transmitter, a (radiation) source, a (radiation) receiver, or a (radiation) detector are disclosed in US Applications No. 18/084,562 and No. 17/900,864, the disclosure of which is hereby incorporated by reference herein in its entirety and made a part of this specification.

The use of ordinal terms such as “first” and “second” does not by itself imply any priority, precedence, or order of one element over another, the chronological sequence in which acts of a method are performed, or the necessity for all the elements to be exist at the same time, but these terms are simply used as labels to distinguish one element having a certain name from another element having the same name. The technical features described in the following embodiments may be mixed or combined in various ways as long as there are no conflicts between them.

In an embodiment, a 2D image may be generated through the use of a complementary metal-oxide-semiconductor (CMOS) image sensor while a 3D point cloud sensor may be implemented by LiDAR. The 3D point cloud sensor emits nonvisible laser and calculate the time it takes for the laser to bounce back, thereby creating individual data points of a 3D point cloud. An array of SPADs may be used as a receiver of the 3D point cloud sensor for 3D depth sensing. A 2D image captured by a CMOS image sensor and a 3D point cloud obtained from a 3D point cloud sensor are outputted separately to external CPU/GPU(s), and the CPU/GPU(s) process/processes and fuse/fuses the 2D image and the 3D depth point cloud for object recognition. Such sensor fusion calls for long processing time and delays decision-making.

In another embodiment, a receiver (e.g., any of 180-1080) of an apparatus (e.g., any of 10, 11, 50-90) may include detector macro-cell(s). Each detector macro-cell (e.g., 280CLLa, 280CLLb, 1280CLLa, 1280CLLb, 1380CLLa, 1380CLLa’, or 1380CLLb) includes at least two SPADs: at least one for 2D imaging and the other for 3D depth measuring. All the SPADs of the apparatus are arranged in an array and formed as a single entity. In this way, the receiver is able to employ certain SPAD(s) (e.g., 1280EM or 280NV) to acquire a 3D point cloud while simultaneously utilizing the other SPAD(s) (e.g., 1280TH or 280V1-280V3) to capture a 2D image. A 2D image and a 3D point cloud obtained by the receiver at once are outputted together to external CPU/GPU(s), and thus the 2D image and the 3D point cloud are fused/combined before the CPU/GPU(s) process/processes the 2D image and the 3D depth point cloud for object recognition. This enhances processing efficiency while preventing delays in decision-making.

In this application, the terms “nonvisible” and “invisible” are used interchangeably and are intended to have the same meaning unless otherwise specified.

In this application, the term “reflection” refers to both specular reflection and diffuse reflection, including surface scattering phenomena.

To sum up, for each pixel (which corresponds to one detector macro-cell), the detector macro-cell has the capacity to comprehensively measure the distance to (a point on) an object using one detector/SPAD and determine the appearance/color/thermal information of (the same point on) the object using another detector/SPAD next to the former detector/SPAD at once. A apparatus may thus efficiently obtain a color/thermal image of object(s) and its corresponding 3D representation known as point cloud data, which is derived by gathering distance-to-object-data, at once.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A receiver, comprising:
at least one detector macro-cell, wherein each of the at least one detector macro-cell comprises:
a first detector, configured to capture first invisible radiation, wherein the first invisible radiation represents radiation emitted from a first source and reflected by an object;
a second detector, configured to capture first visible radiation reflected by or originating from the object;
a third detector, configured to capture second visible radiation reflected by or originating from the object; and
a fourth detector, configured to capture third visible radiation reflected by or originating from the object; wherein
the first visible radiation, the second visible radiation, and the third visible radiation are red, green, and blue, respectively,
the first visible radiation, the second visible radiation, and the third visible radiation are red, green, and yellow, respectively, or
the first visible radiation, the second visible radiation, and the third visible radiation are cyan, magenta, and yellow, respectively;
wherein the first detector to the fourth detector are arranged in a first array to constitute one detector macro-cell.

2. The receiver of claim 1, wherein each of the at least one detector macro-cell further comprises:
a fifth detector, configured to capture second invisible radiation reflected by or originating from the object; or
a sixth detector, configured to capture an electromagnetic wave emitted from a second source and reflected by the object;
wherein the fifth detector or the sixth detector is also arranged in the first array.

3. The receiver of claim 1,
wherein the first invisible radiation is near-infra-red;
wherein second invisible radiation captured by a fifth detector is infra-red; or
wherein an electromagnetic wave captured by a sixth detector is a microwave or radio wave.

4. The receiver of claim 1, wherein an electromagnetic wave captured by a sixth detector ranges from hundreds of mega Hertz to 77GHz.

5. The receiver of claim 1,
wherein the first detector or a sixth detector is configured to only respond to the first source or a second source to measure a distance to the object;
wherein the second, third and fourth detectors are configured to detect its environment except the transmitter to obtain color information of the object;
wherein a fifth detector is configured to detect its environment except the transmitter to obtain thermal information of the object.

6. The receiver of claim 1,
wherein the first detector is a silicon based single photon avalanche diode or a Geiger mode avalanche diode;
wherein the second to fourth detectors are color imaging sensors or image intensifier sensors;
wherein a fifth detector is a thermal imaging sensor.

7. The receiver of claim 1, wherein the first detector is masked with a non-visible band-pass filter to capture the first invisible radiation, and the second, third, or fourth detector is masked with a color filter to capture the first, second, or third visible radiation.

8. The receiver of claim 1,
wherein the receiver comprises a plurality of detector macro-cells arranged in a second array;
wherein the detector macro-cells comprises a first detector macro-cell and a second detector macro-cell;
wherein a first detector, a second detector, a third detector, and a fourth detector of the first detector macro-cell are adjacent to one another;
wherein the first detector macro-cell and the second detector macro-cell have identical structures.

9. A light detection and ranging (LiDAR) apparatus, comprising:
a transmitter, comprising a first source; and
a receiver, optically coupled to the transmitter and comprising at least one detector macro-cell, wherein each of the at least one detector macro-cell comprises:
a first detector, configured to capture first invisible radiation, wherein the first invisible radiation represents radiation emitted from the first source and reflected by an object;
a second detector, configured to capture first visible radiation reflected by or originating from the object;
a third detector, configured to capture second visible radiation reflected by or originating from the object; and
a fourth detector, configured to capture third visible radiation reflected by or originating from the object, wherein
the first visible radiation, the second visible radiation, and the third visible radiation are red, green, and blue, respectively,
the first visible radiation, the second visible radiation, and the third visible radiation are red, green, and yellow, respectively, or
the first visible radiation, the second visible radiation, and the third visible radiation are cyan, magenta, and yellow, respectively;
wherein the first detector to the fourth detector are arranged in a first array to constitute one detector macro-cell.

10. The LiDAR apparatus of claim 9, wherein each of the at least one detector macro-cell further comprises:
a fifth detector, configured to capture second invisible radiation reflected by or originating from the object; or
a sixth detector, configured to capture an electromagnetic wave emitted from a second source and reflected by the object;
wherein the fifth detector or the sixth detector is also arranged in the first array.

11. The LiDAR apparatus of claim 9,
wherein the first detector or a sixth detector is configured to only respond to the first source or a second source to measure a distance to the object;
wherein the second, third and fourth detectors are configured to detect its environment except the transmitter to obtain color information of the object;
wherein a fifth detector is configured to detect its environment except the transmitter to obtain thermal information of the object.

12. The LiDAR apparatus of claim 9,
wherein the first detector is a silicon based single photon avalanche diode or a Geiger mode avalanche diode;
wherein the second to fourth detectors are color imaging sensors or image intensifier sensors;
wherein a fifth detector is a thermal imaging sensor.

13. The LiDAR apparatus of claim 9, wherein a ratio of a pitch between one first detector and another adjacent first detector in a first direction to a width of the first detector in the first direction is proportional to a ratio of a pitch between one first source and another adjacent first source in a second direction to a width of the radiation source in the second direction, and the first direction is parallel or nonparallel to the second direction.

14. The LiDAR apparatus of claim 9, wherein the LiDAR apparatus is a coaxial LiDAR apparatus or a non-coaxial LiDAR apparatus, and the transmitter is configured to scan or flash a two-dimensional field of view.

15. The LiDAR apparatus of claim 9, further comprising:
a beam steering unit, configured to steer the first invisible radiation, wherein the at least one detector macro-cell is arranged in a one-dimensional array or a two-dimensional array, and at least one source comprising the first source or a second source is arranged in a one-dimensional array or a two-dimensional array.

16. A color depth integration method, comprising:
capturing, by a first detector of a detector macro-cell, first invisible radiation, wherein the first invisible radiation represents radiation emitted from a first source and reflected by an object;
capturing, by a second detector of the detector macro-cell, first visible radiation reflected by or originating from the object;
capturing, by a third detector of the detector macro-cell, second visible radiation reflected by or originating from the object; and
capturing, by a fourth detector of the detector macro-cell, third visible radiation reflected by or originating from the object, wherein
the first visible radiation, the second visible radiation, and the third visible radiation are red, green, and blue respectively,
the first visible radiation, the second visible radiation, and the third visible radiation are red, green, and yellow respectively, or
the first visible radiation, the second visible radiation, and the third visible radiation are cyan, magenta, and yellow respectively;
wherein the first detector to the fourth detector are arranged in a first array to constitute the detector macro-cell.

17. The color depth integration method of claim 16, further comprising:
capturing, by a fifth detector of the detector macro-cell, second invisible radiation reflected by or originating from the object; or
capturing, by a sixth detector of the detector macro-cell, an electromagnetic wave emitted from a second source and reflected by the object;
wherein the fifth detector or the sixth detector is also arranged in the first array.

18. The color depth integration method of claim 16,
wherein the first invisible radiation is near-infra-red;
wherein second invisible radiation captured by a fifth detector is infra-red; or
wherein an electromagnetic wave captured by a sixth detector is a microwave or radio wave.

19. The color depth integration method of claim 16, further comprising:
associating a distance to a point in space with color or thermal information of the point;
wherein the first detector or a sixth detector is configured to only respond to the first source or a second source to measure the distance to the point;
wherein the second, third and fourth detectors are configured to detect its environment except the transmitter to obtain the color information of the point;
wherein a fifth detector is configured to detect its environment except the transmitter to obtain the thermal information of the point.

20. The color depth integration method of claim 16,
wherein the first detector is a silicon based single photon avalanche diode or Geiger mode avalanche diode;
wherein the second to fourth detectors are color imaging sensors or image intensifier sensors;
wherein a fifth detector is a thermal imaging sensor.
